(19) United States
(12) Patent Application Publication
(10) Pub. No.: US 2025/0356109 A1
(43) Pub. Date: Nov. 20, 2025

(54) REFINING INPUT PROMPTS TO GENERATIVE NEURAL NETWORKS

(71) Applicant: Google LLC, Mountain View, CA (US)

(72) Inventors: Ian MacGillivray, Brooklyn, NY (US); Andrew Robert Levine, Washington, DC (US); Sai Kiran Gorthi, Santa Clara, CA (US); Noah Charles Xin Semus, New York, NY (US); Phillip Edward Dieter Maier, Cambridge, MA (US); Yilun Liu, Mountain View, CA (US); Kristin Yim, San Francisco, CA (US)

(21) Appl. No.: 19/208,519

(22) Filed: May 14, 2025

Related U.S. Application Data
(60) Provisional application No. 63/647,566, filed on May 14, 2024.

(51) Int. Cl. G06F 40/166; G06F 40/284; G06F 40/30; G06F 40/40

(52) U.S. Cl. CPC G06F 40/166; G06F 40/284; G06F 40/30; G06F 40/40

(57) ABSTRACT

Methods, systems, and apparatus, including computer programs encoded on computer storage media, for refining input prompts to generative neural networks. One of the methods includes receiving an input prompt to a generative neural network; generating, from the input prompt, a language model input; processing the language model input using a language model neural network to generate an output that (i) identifies one or more initial text segments from the text sequence and (ii) includes, for each of the identified initial text segments, one or more initial candidate refinements for the text segment; identifying, using the output, (i) one or more final text segments from the text sequence and (ii) for each of the final text segments, one or more final candidate refinements for the final text segment; and providing, for presentation in user interface, data identifying the one or more final candidate refinements for the final text segments.

### CROSS-REFERENCE TO RELATED APPLICATION

This application claims priority to U.S. Provisional Application No. 63/647,566, filed on May 14, 2024. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that allows a user to refine an input prompt to a generative neural network, i.e., to modify one or more of the text segments in an initial prompt that has been submitted by a user. After the input prompt has been refined, the refined prompt can be provided as input to the generative neural network, which uses the refined prompt to generate a data item.

Particular embodiments of the subject matter described in this specification can be implemented so as to realize one or more of the following advantages.

Many existing systems allow users to submit prompts to interface with one or more generative models. For example, some systems allow users to submit prompts through a user interface that are then provided as input to a generative model. As another example, some systems allow users to access a generative model through an application programming interface (API).

However, the quality of the data item that is generated by a given generative model can vary widely between different inputs (“prompts”) and even between prompts that are semantically similar. Moreover, how to format a prompt to the generative model is frequently not apparent to users. Thus, in many cases, because generating a data item using a generative model is computationally expensive and can incur significant latency, generating a high-quality data item can require many different candidate data items to be generated in response to many different prompts, consuming a large number of computational resources and harming the user experience.

Various existing approaches attempt to assist users in generating prompts that can be effectively processed by a generative model, i.e., in generating prompts that, when processed by the generative model, cause the generative model to generate a high-quality output data item.

For example, prompt rewriting is a technique that automatically transforms a user's input to a generative model, aiming to improve the quality of the model output or to address characteristics such as diversity. This mutates the entire prompt, rather than allowing for granular exploration and discovery, and is often invisible to the user. That is, a process running in the “background” rewrites or augments a user prompt and provides the rewritten prompt as input to the model without further input to the user. The user therefore receives little to no feedback on how to better interface with the generative model.

As another example, some techniques allow users to select one of multiple pre-set options that each correspond to a different prompt for the generative model. This technique guides users towards inputs that are technically feasible and may be creatively interesting. However, this does not work with the user's own freehand inputs and is inherently limited to the predetermined design choices, limiting the user's ability to interface with the generative model (because although the generative model can respond to any appropriate free text prompt, the user is limited to selecting from a relatively small set of pre-set options).

This specification describes techniques that address these shortcomings of these and other techniques and solves for the user problem by providing an option to the user to refine individual segments of the prompt with prompt-specific alternatives. This may guide a user towards more depth, breadth, or model-applicable inputs for any arbitrary concept. In particular, the described techniques leverage a language model neural network to propose refinements to each of one or more segments of the prompt and allow users to refine the prompt using the proposed refinements.

For example, given a user input “Photorealistic woman wearing elaborate earrings frontlit, full body portrait, hyperrealistic, Rembrandt lighting,” the described techniques may offer Surreal/Abstract/Impressionistic as alternatives to Photorealistic, terms that a user may be unaware of creatively, that may be well-suited as inputs to a given model. In the same input, the described techniques may offer Split/Broad/Butterfly as alternative options to Rembrandt, for lighting types.

Thus, the described techniques provide for a transparent and flexible way to improve the user—generative model interaction by allowing users to flexibly refine portions of input prompts in a transparent manner to effectively explore the space of possible prompts that can yield a high-quality data item.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a diagram of an example prompt refinement system.

FIG. 2 is a flow diagram of an example process for refining an input prompt.

FIG. 3A shows an example user interface.

FIG. 3B shows the example user interface after a user has submitted an input selecting an identified text segment.

Like reference numbers and designations in the various drawings indicate like elements.

### DETAILED DESCRIPTION

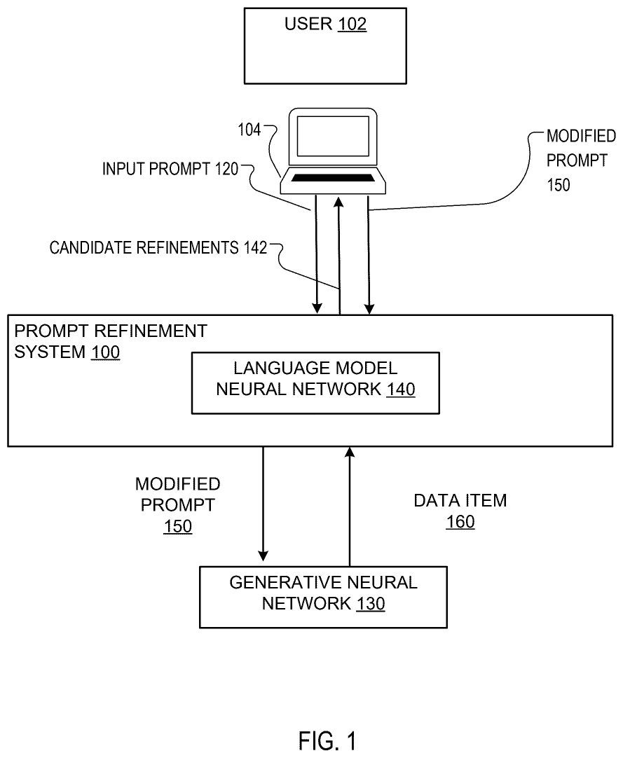

FIG. 1 shows an example prompt refinement system 100. The prompt refinement system 100 is an example of a system implemented as computer programs on one or more computers in one or more locations, in which the systems, components, and techniques described below can be implemented.

The prompt refinement system 100 is a system that interfaces between a user 102 of a user device 104 and a generative neural network 110.

Generally, the prompt refinement system 100 receives, from the user device 104, an input prompt 120 to the generative neural network 130.

The input prompt 120 is a text prompt that includes a sequence of text tokens. Each text token is a token from a vocabulary of text tokens that each represent a respective unit of text, e.g., a set of tokens that includes words, characters, word pieces, or other text symbols.

That is, the user 102 submits, through the user device 104, a request for a data item to be generated by the generative neural network 130. The request includes a prompt, i.e., the input prompt 120, that describes the desired content of the requested data item.

The generative neural network 130 can be any appropriate generative neural network that generates a data item by processing an input that includes a prompt. A “data item” is an item of content of a corresponding type. For example, a data item can be any of an image, an audio signal, e.g., representing speech, music, or both, a video, and so on.

For example, the generative neural network 130 can be an image generation neural network that generates images in response to user inputs. Examples of such neural networks include diffusion models and auto-regressive image generation neural networks. As particular examples, the generative neural network 130 can be the Parti model described in Scaling Autoregressive Models for Content-Rich Text-to-Image Generation, arXiv:2206.10789, the MobileDiffusion model described in MobileDiffusion: Instant Text-to-Image Generation on Mobile Devices, arXiv:2311.16567, or the Imagen model described in Photorealistic Text-to-Image Diffusion Models with Deep Language Understanding, arXiv:2205.11487.

As another example, the generative neural network 130 can be an audio generation neural network that generates audio signals, e.g., audio signals representing speech, music, or other audio, in response to user inputs. Examples of such neural networks include diffusion models and auto-regressive audio generation neural networks. As particular examples, the generative neural network 130 can be the AudioLM model described in AudioLM: a Language Modeling Approach to Audio Generation, arXiv:2209.03143, or the MusicLM model described in MusicLM: Generating Music from Text, arXiv:2301.1132.

As another example, the generative neural network 130 can be a video generation neural network that generates videos in response to user inputs. Examples of such neural networks include diffusion models and auto-regressive video generation neural networks. As particular examples, the neural network 130 can be the Phenaki model described in Phenaki: Variable Length Video Generation From Open Domain Textual Description, arXiv:2210.02399 or the WALT model described in Photorealistic Video Generation with Diffusion Models, arXiv:2312.06662.

In some cases, rather than providing input to only one generative neural network 130, the system 100 can interface with multiple different generative neural networks 130. For example, the system 100 can interface between users and two or more of: a generative neural network 130 that generates images, a generative neural network 103 that generates videos, a generative neural network 130 that generates audio, and so on.

In some cases, the request can also include other data.

For example, the request can include one or more context data items that the generative neural network 130 uses as context when generating the data item.

In some implementations, rather than simply directly providing the prompt 120 as input to the generative neural network 130, the system 100 instead allows the user 102 to refine the prompt before the prompt is submitted to the generative neural network 130.

In some other implementations, the system 100 can provide the input prompt 120 to the generative neural network 130 and obtain a data item that was generated by the generative neural network 130 by processing the input prompt 120. The system 100 can then allow the user 102 to refine the prompt 120 while viewing the data item that was generated by the generative neural network 130 in response to the prompt 120.

In particular, the system 100 uses a language model neural network 140 to identify one or more text segments from the text sequence and, for each of the identified text segments, one or more candidate refinements 142 for the identified text segment.

The system 100 then provides, for presentation in user interface of the user device 104, data identifying the one or more candidate refinements 142 for the text segments.

Generally, the user interface allows the user 102 to generate a modified prompt 150 by replacing one or more of the identified text segments with one of the candidate refinements 142 for the identified text segment.

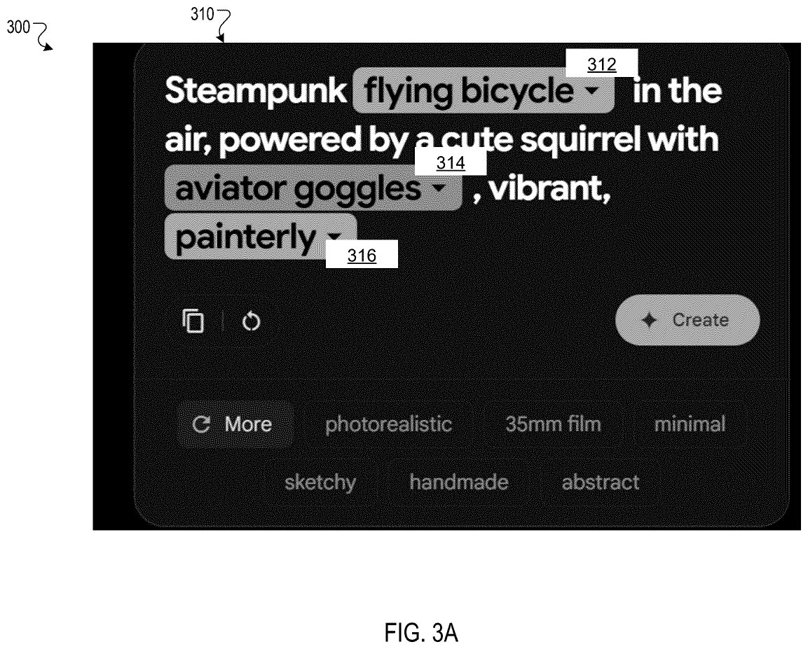

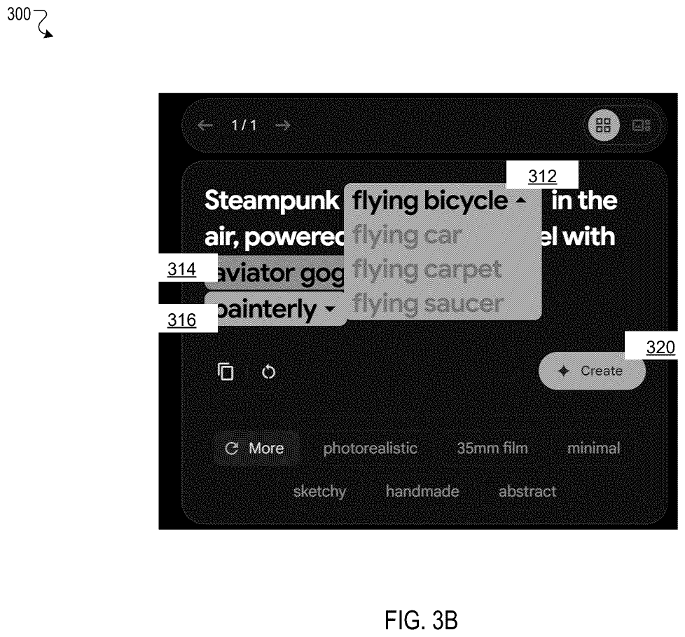

One example of a user interface is described below with reference to FIGS. 3A and 3B.

Once the user 102 has generated the modified prompt 150, the system 100 receives, from the user device 104, the modified prompt 150 and provides an input that includes the modified prompt 150 and, optionally, other data, to the generative neural network 130.

The system 100 obtains, as output from the generative neural network 130, a generated data item 160 and provides the generated data item 160 for presentation to the user 102 on the user device 104.

The system 100 can continue allowing the user to further refine the modified prompt 150 to generate additional data items 160. That is, the system 100 can continue leveraging the language model neural network 140 to allow the user to explore the space of input prompts that can result in a data item having the user's desired properties to be generated.

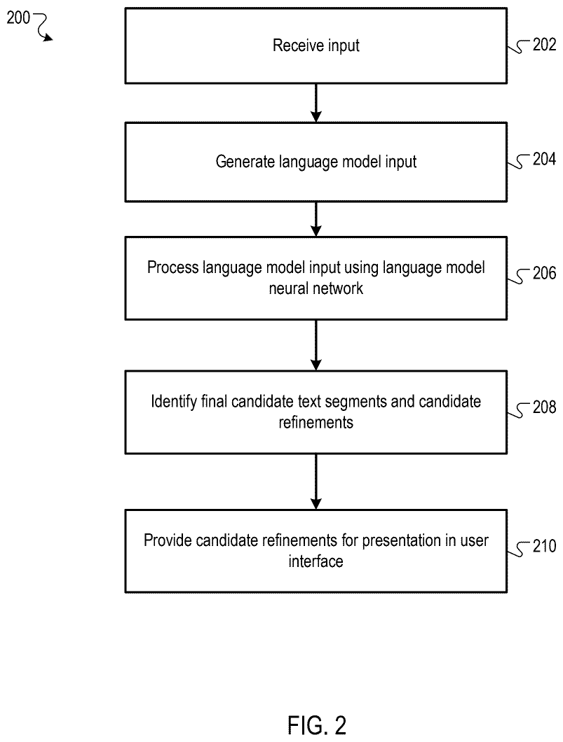

FIG. 2 is a flow diagram of an example process 200 for refining an input prompt. For convenience, the process 200 will be described as being performed by a system of one or more computers located in one or more locations. For example, a prompt refinement system, e.g., the prompt refinement system 100 depicted in FIG. 1, appropriately programmed in accordance with this specification, can perform the process 200.

The system receives an input prompt to a generative neural network (step 202). As described above, the input prompt generally includes a text sequence of text tokens.

The system generates, from the input prompt, a language model input to a language model neural network (step 204).

For example, the system can combine the input prompt with a pre-determined prompt for the language model in order to generate the language model input.

As another example, the system can apply one or more rules or criteria to the input prompt in order to determine whether certain terms in the input prompt need to be removed or modified prior to including the input prompt in the language model input. For example, the system can check whether any terms in the input prompt violate rules or constraints on appropriateness or safety.

The system processes the language model input using the language model neural network to generate a language model output (step 206).

The language model output (i) identifies one or more initial text segments from the text sequence and (ii) includes, for each of the identified initial text segments, one or more initial candidate refinements for the text segment.

Each of the one or more initial text segments includes a respective proper subset of the text tokens in the text sequence. That is, each initial text segment includes less than all of the tokens in the text sequence. For example, the initial text segments can include words or phrases within the input prompt, but any given text segment is generally not the entire input prompt.

Each candidate refinement is a text segment that can replace the corresponding text segment in the input prompt.

More generally, the language model output identifies the one or more initial text segments and includes structured information for each of the identified text segment.

The structured information includes the candidate refinements for the text segment, but can also include additional information.

For example, the structured information can include information about semantically-related segments. As one example, the structured information can identify that multiple semantically-related segments should be updated in tandem if a user chooses to refine. That is, the structured information can identify, for each of the semantically-related segments and for each candidate refinement for the semantically-related segment, corresponding candidate refinements for the other semantically-related segments. In response to the user selecting the candidate refinement, the system can either automatically refine the other semantically-related segments to the corresponding candidate refinements or provide, in the user interface, an indication of the corresponding candidate refinements.

The structured information can also include information about the types of refinement, allowing for further user control, e.g., a refinement that improves the diversity of the prompt, or a refinement that alters the aesthetic style of the output. That is, when presented in the user interface, each candidate refinement can be presented along with data that identifies the type of the refinement.

More generally, by providing structured data in the response (which is then sent to the user device), a user interface can allow a user to more deeply explore the refinements through user interface elements, e.g., toggles and controls, in the user interface without additional calls to a server. That is, by providing this structured information, users can obtain additional information about candidate refinements and switch between candidate refinements locally on the user device and without needing to call the language model neural network, which is generally remote from the user device.

The language model neural network is a neural network that is configured to process an input to generate an output that includes a probability distribution over a set of text tokens in vocabulary of tokens, with the probability for each token representing the likelihood that the token immediately follows the input.

The vocabulary of tokens generally include text tokens and can optionally include tokens representing one or more other modalities, e.g., audio, image, video, and so on. The text tokens can include any appropriate tokens that appear in natural language text, e.g., ASCII characters, words, word pieces, or differently distributed n-grams. For example, the vocabulary of text tokens can be fixed or can have been generated by applying an appropriate tokenizer, e.g., a byte pair encoding tokenizer or the SentencePiece tokenizer to a corpus of text.

For example, the language model neural network can be an auto-regressive language model neural network.

The language model neural network is referred to as an auto-regressive neural network because the neural network auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence (a “context sequence”).

For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within a candidate output sequence, the neural network can process the current input sequence to generate a score distribution, e.g., a probability distribution, that assigns a respective score, e.g., a respective probability, to each text token in the vocabulary of text tokens. The neural network can then select, as the particular token, a text token from the vocabulary using the score distribution. For example, the neural network can greedily select the highest-scoring token or can sample, e.g., using nucleus sampling or another sampling technique, a token from the distribution.

As a particular example, the language model neural network can be an auto-regressive Transformer-based neural network that includes (i) a plurality of attention blocks that each apply a self-attention operation and (ii) an output subnetwork that processes an output of the last attention block to generate the score distribution.

The neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv:2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Gemini (described in arXiv:2403.05530), Gemma (described in arXiv:2403.08295), and PaliGemma (described in arXiv:2412.03555).

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, prior to the use of the language model neural network by the system, the language model neural network can have already been trained across one or more previous training stages.

For example, the one or more previous training stages can include a pre-training stage. During the pre-training stage, the language model neural network can have been trained by the system or a separate system on a next token prediction task, e.g., a task that requires predicting, given a current sequence of tokens, the next token that follows the current sequence in the training data.

As a particular example, the language model neural network can have been trained on a maximum-likelihood objective on a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

As another example, the one or more previous training stages can include one or more additional training stages, e.g., that occur after the pre-training stage. For example, the one or more previous training stages can include any one or more of: a supervised fine-tuning stage, a reinforcement learning stage, e.g., reinforcement learning from human or other feedback, a preference learning stage, an instruction tuning stage, and so on.

The system can cause the language model neural network to generate the language model output described above in any of a variety of ways.

For example, the system can include, in the language model input, a k-shot prompt that includes k examples, where each example includes an example prompt and an example language model output generated for the example prompt. Generally, k can be a fixed integer that is greater than or equal to one.

As another example, the system can include, in the language model input, a natural language instruction that explains how the language model neural network should generate the language model output.

As yet another example, the system can have fine-tuned the language model neural network to improve the performance of the neural network in accurately generating language model outputs of the type required. For example, the system can have fine-tuned the language model neural network on a fine-tuning data set that includes multiple training examples, with each training example including an input prompt and a target language model output that identifies one or more segments in the input prompt and includes respective structured data for each identified segment.

The system identifies, using the language model output, (i) one or more final text segments from the text sequence and (ii) for each of the final text segments, one or more final candidate refinements for the final text segment (step 208).

In some implementations, the system uses the initial text segments and corresponding initial refinements as the final text segments and final refinements.

In some other implementations, the system can modify one or more of the initial segments and refinements to generate final segments and corresponding final refinements.

For example, the system can apply one or more rules or criteria to the initial refinements in order to determine whether certain terms in the refinements need to be removed or modified prior to being included in the final refinements. For example, the system can check whether any terms in the initial refinements violate rules or constraints on appropriateness or safety.

As another example, the system can maintain historical data. The historical data can be specific to the current user or may be data generated based on interactions of multiple different users. As an example of this, the maintained historical data can indicate, for a set of candidate refinements, how frequently the candidate refinement is adopted, i.e., inserted into an input prompt after being suggested by the system. As another example of this, the maintained historical data can indicate, for a set of candidate text segment, how frequently the text segment is refined by users.

The system can then use this historical data to modify the initial refinements or initial text segments. For example, the system can remove any refinements from the initial refinements that are adopted by the current user or by the multiple different users less than a threshold proportion of the time that they are suggested by the system. As another example, the system can remove the initial refinements for the text segments that the data indicates are refined by the current user or by the multiple different users less than a threshold proportion of the time that they are suggested by the system.

In some examples, the determination of whether to modify the initial output of the language model neural network may be context-dependent based on a specific prompt. For example, if the system determines that the prompt relates to photorealistic people, the system can determine that refinements relating to lighting and contrast are more beneficial than refinements relating to pose or setting. This can be determined after processing the prompt to discover its context, e.g., using a machine learning model. For example, the system can process the prompt using the language model neural network or a different machine learning model to generate an output that identifies the context for the input prompt. The system can then process an input that identifies the context and the refinements using the language model neural network or a different machine learning model to generate an output that (i) identifies the refinements that are relevant to the context or (ii) identifies the refinements that are not relevant to the context. The system can then determine to include in the final refinements (i) only the refinements that were identified as relevant to the context or (ii) only the refinements that were not identified as not relevant to the context.

The system provides, for presentation in user interface of a user device, data identifying the one or more final candidate refinements for the final text segments. The user interface allows a user to generate a modified prompt by replacing one or more of the final text segments with one of the final candidate refinements for the final text segment (step 210).

If the system receives an indication that the user has submitted one or more inputs through the user interface refining the initial prompt by replacing one or more of the final text segments with one of the final candidate refinements for the final text segment, the system can provide the resulting modified prompt as input to the generative neural network and obtain, in response, an output data item generated in response to the modified prompt.

The system can then provide the output data item for presentation to the user in the user device. In some implementations, after providing the output data item for presentation, the system can continue to present the (not yet selected) final candidate refinements to allow the user to further modify the prompt. In some other implementations, after providing the output data item for presentation, the system can perform the process 200 starting from the modified prompt to generate a new set of a final candidate refinements for a new set of final text segments of the modified prompt.

FIG. 3A shows an example of a user interface 300 that shows an initial prompt 310 and allows a user to refine the initial prompt 310.

In particular, the user interface 300 displays the initial prompt 310 “Steampunk flying bicycle in the air, powered by a cute squirrel with aviator goggles, vibrant, painterly.”

The user interface 300 also identifies three text segments 312, 314, and 316 that have been identified as candidates for refinement by the system 100.

In particular, the user interface 300 displays each identified text segment 312, 314, and 316 in association with a respective user interface element that, when selected by a user, presents the candidate refinements. For example, the text segments 312, 314, and 316 can be displayed in a visually distinct manner from the other text segments of the initial prompt 310 that were not identified as candidates for refinement by the system 100.

FIG. 3B shows an example of the user interface 300 after a user has selected the user interface element associated with an identified text segment, i.e., the identified text segment 312.

As can be seen from FIG. 3B, in response to the user input selecting the user interface element, the user interface is updated to display the candidate refinements for the identified text segment 312.

If the user selects one of the candidate refinements, the system can update the prompt to include the candidate refinement in place of the identified text segment 312.

Thus, as can be seen from the examples of FIG. 3A and FIG. 3B, rather than rewriting the entire input prompt, the system 100 instead identifies various text segments within the input prompt as candidates for being refined and allows the user to select from various candidate refinements for each identified text segment.

Once the user has modified the prompt as needed using the candidate refinements, the user can select the “create” user interface element 320 to cause the system 100 to provide the resulting refined prompt as input to the generative neural network. The system 100 can then display the generated data item to the user, e.g., in the user interface 300 or in a different user interface. In some other cases, rather than require the user to select the create user interface element 320, the system 100 can automatically provide the current prompt as input to the generative neural network each time the user selects a refinement.

While the above description describes that the system generates the data item after receiving the modified input prompt, in some cases the system also generates a data item from the initial input prompt. In these cases, the system can display the candidate refinements along with the data item generated from the initial input prompt in the user interface, e.g., so that the user can refer to the initially-generated data item to identify how the initial prompt should be modified.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
one or more computers; and
one or more storage devices storing instructions that, when executed by the one or more computers, cause the one or more computers to perform operations comprising:
receiving an input prompt to a generative neural network, the input prompt comprising a text sequence of text tokens;
generating, from the input prompt, a language model input to a language model neural network;
processing the language model input using the language model neural network to generate a language model output that (i) identifies one or more initial text segments from the text sequence and (ii) includes, for each of the identified initial text segments, one or more initial candidate refinements for the text segment, wherein each of the one or more initial text segments comprises a respective proper subset of the text tokens in the text sequence;
identifying, using the language model output, (i) one or more final text segments from the text sequence and (ii) for each of the final text segments, one or more final candidate refinements for the final text segment; and
providing, for presentation in user interface of a user device, data identifying the one or more final candidate refinements for the final text segments, wherein the user interface allows a user to generate a modified prompt by replacing one or more of the final text segments with one of the final candidate refinements for the final text segment.

2. The system of claim 1, the operations further comprising:
receiving, from the user device, the modified prompt.

3. The system of claim 2, the operations further comprising:
providing an input comprising the modified prompt to the generative neural network;
obtaining, as output from the generative neural network, a generated data item; and
providing the generated data item for presentation on the user device.

4. The system of claim 3, wherein the input to the generative neural network further comprises an initial data item.

5. The system of claim 3, wherein the generated data item is an image.

6. The system of claim 3, wherein the generated data item is a video.

7. The system of claim 3, wherein the generated data item is an audio signal.

8. The system of claim 1, wherein generating, from the input prompt, a language model input to a language model neural network comprises:
modifying the input prompt prior to including the input prompt in the language model input.

9. The system of claim 1, wherein identifying, using the language model output, (i) one or more final text segments from the text sequence and (ii) for each of the final text segments, one or more final candidate refinements for the final text segment comprises one or more of:
removing one of the initial text segments; or
removing one of the initial candidate refinements for one of the initial text segments.

10. The system of claim 1, wherein the language model output includes, for each of the identified initial text segments, respective structured data that includes the one or more initial candidate refinements for the text segment.

11. The system of claim 10, wherein the respective structured data includes information about semantically-related segments to the identified initial text segment.

12. The system of claim 10, wherein the respective structured data includes information identifying, for each candidate refinement, a respective type of the refinement.

13. The system of claim 10, wherein user interface includes one or more user interface elements corresponding to the respective structured data.

14. One or more computer-readable storage media storing instructions that when executed by one or more computers cause the one or more computers to perform operations comprising:
receiving an input prompt to a generative neural network, the input prompt comprising a text sequence of text tokens;
generating, from the input prompt, a language model input to a language model neural network;
processing the language model input using the language model neural network to generate a language model output that (i) identifies one or more initial text segments from the text sequence and (ii) includes, for each of the identified initial text segments, one or more initial candidate refinements for the text segment, wherein each of the one or more initial text segments comprises a respective proper subset of the text tokens in the text sequence;
identifying, using the language model output, (i) one or more final text segments from the text sequence and (ii) for each of the final text segments, one or more final candidate refinements for the final text segment; and
providing, for presentation in user interface of a user device, data identifying the one or more final candidate refinements for the final text segments, wherein the user interface allows a user to generate a modified prompt by replacing one or more of the final text segments with one of the final candidate refinements for the final text segment.

15. A method performed by one or more computers, the method comprising:
receiving an input prompt to a generative neural network, the input prompt comprising a text sequence of text tokens;
generating, from the input prompt, a language model input to a language model neural network;
processing the language model input using the language model neural network to generate a language model output that (i) identifies one or more initial text segments from the text sequence and (ii) includes, for each of the identified initial text segments, one or more initial candidate refinements for the text segment, wherein each of the one or more initial text segments comprises a respective proper subset of the text tokens in the text sequence;
identifying, using the language model output, (i) one or more final text segments from the text sequence and (ii) for each of the final text segments, one or more final candidate refinements for the final text segment; and
providing, for presentation in user interface of a user device, data identifying the one or more final candidate refinements for the final text segments, wherein the user interface allows a user to generate a modified prompt by replacing one or more of the final text segments with one of the final candidate refinements for the final text segment.

16. The method of claim 15, further comprising:
receiving, from the user device, the modified prompt.

17. The method of claim 16, further comprising:
providing an input comprising the modified prompt to the generative neural network;
obtaining, as output from the generative neural network, a generated data item; and
providing the generated data item for presentation on the user device.

18. The method of claim 17, wherein the input to the generative neural network further comprises an initial data item.

19. The method of claim 15, wherein generating, from the input prompt, a language model input to a language model neural network comprises:
modifying the input prompt prior to including the input prompt in the language model input.

20. The method of claim 15, wherein identifying, using the language model output, (i) one or more final text segments from the text sequence and (ii) for each of the final text segments, one or more final candidate refinements for the final text segment comprises one or more of:
removing one of the initial text segments; or
removing one of the initial candidate refinements for one of the initial text segments.
